(19) United States
(12) Patent Application Publication
(10) Pub. No.: US 2012/0047972 A1
(43) Pub. Date: Mar. 1, 2012

(54) ELECTRONIC KEY FOR MERCHANDISE SECURITY DEVICE

(75) Inventors: Jeffrey A. Grant, Charlotte, NC (US); Christopher J. Fawcett, Charlotte, NC (US)

(73) Assignee: INVUE SECURITY PRODUCTS INC., Charlotte, NC (US)

(21) Appl. No.: 13/222,225

(22) Filed: Aug. 31, 2011

Related U.S. Application Data
(60) Provisional application No. 61/379,248, filed on Sep. 1, 2010.
(60) Provisional application No. 61/441,352, filed on Feb. 10, 2011.

(51) Int. Cl. E05B 47/00; G08B 29/00

(52) U.S. Cl. 70/77; 340/5.65

(57) ABSTRACT

An electronic key including an internal power source is provided for transferring electrical power to a merchandise security device to operate a mechanical lock mechanism. In one embodiment, the key transfers power to the device via electrical contacts disposed on a transfer probe of the electronic key and corresponding electrical contacts disposed within a transfer port of the device when the transfer probe engages the transfer port. In another embodiment, the key transfers power to the device via inductive transfer as a result of passing an electrical current through an inductive coil disposed within the transfer probe to generate a magnetic field in the vicinity of a corresponding inductive coil disposed within the transfer port and thereby induce an electric current in the inductive coil of the device. In other embodiments, the electronic key is programmed with a security code and the key initially programs the merchandise security device with the security code and subsequently determines whether the security code of the key matches the security code of the device to permit the key to transfer power to the device.

### CROSS REFERENCE TO RELATED APPLICATIONS

This non-provisional application claims the benefit of U.S. Provisional Application No. 61/379,248 filed on Sep. 1, 2010, and U.S. Provisional Application No. 61/441,352 filed on Feb. 10, 2011.

### FIELD OF THE INVENTION

The present invention relates generally to merchandise display security systems and methods for protecting an item of merchandise from theft. More particularly, the invention relates to an electronic key for transferring power to a merchandise security device, such as a security display, security fixture or security packaging, of the type commonly used to store and/or display an item of merchandise vulnerable to theft. In the exemplary embodiments shown and described herein, the invention is a programmable electronic key for transferring both data and electrical power to a merchandise security device.

### BACKGROUND OF THE INVENTION

It is common practice for retailers to store and/or display relatively expensive items of merchandise on or within a merchandise security device, such as a security display (e.g. alarming stand), security fixture (e.g. locking hook, shelf, cabinet, etc.) or security packaging (e.g. merchandise keeper). Regardless, the security device stores and/or displays an item of merchandise so that a potential purchaser may view, and in some instances, interact with the item before making a decision whether to purchase the item. At the same time, the item is secured on or within the merchandise security device so as to prevent, or at least deter, theft of the item. The value of the item, however, may make it an attractive target for a shoplifter despite the presence of a merchandise security device. A determined shoplifter may attempt to detach the item from the security display or to remove the item from the security fixture or from within the security packaging. Alternatively, the shoplifter may attempt to remove the all or a portion of the security device from the display area along with the item.

In the case of a secure display or secure fixture, the security device is oftentimes firmly attached to a support, such as a pegboard, wire grid, horizontal bar rack, slatwall (also known as slatboard), wall, table, desk, countertop or like structure. In some instances, the security device is secured to the support using a mechanical lock mechanism operated by a non-programmable key, for example a conventional tumbler lock or a magnetic lock. In other instances, the security device is secured to the support using an electronic lock mechanism operated by a programmable key, for example an alarming merchandise display stand having a sensor and a sensor monitoring circuit operatively coupled to an alarm and responsive to an energy signal received from the programmable key, to initially arm the alarm and to subsequently disarm the alarm.

A mechanical lock mechanism operated by a non-programmable key is relatively inexpensive and can be made sufficiently strong to prevent the security device from being physically separated from the support. However, the key for such a lock mechanism generally is not unique. Thus, the key operates the lock mechanism on most, if not all, of the same type of security devices in a display area, as well as in other display areas within the same or different retail stores. As a result, numerous security devices in different retail stores are compromised if any one of the non-programmable keys is stolen or duplicated. Conversely, if each key is unique or if there are only a few different keys, an authorized person must identify and locate the key that matches the lock mechanism of a particular security device. Locating a matching key is time consuming and may cause the customer to lose interest in purchasing the item if a sales associate is unable to quickly remove the item of merchandise from the security device. Worse yet, if the matching key is lost or stolen, the security device cannot be unlocked and the item of merchandise cannot be removed, replaced, substituted or sold until a replacement key is obtained. Regardless, an unacceptably large portion of a retailer's expense for merchandise security is consumed by the purchase of replacement keys, or alternatively, the cost of re-keying merchandise security devices for new keys.

Alternatively, a mechanical lock mechanism having a predetermined non-programmable combination, such as a common combination lock, may be utilized. However, the aforementioned disadvantages exist for the same reasons regardless of whether the combination is the same for each lock mechanism, whether the combination is unique, or whether multiple combinations are provided for different security devices. Specifically, only a minimum level of security is obtained when each lock mechanism utilizes the same combination. Although a higher level of security is obtained when the combination for each security device is unique or when multiple combinations are provided for different security devices, the expense of operating and maintaining such a merchandise display security system are not justified in most circumstances.

An electronic lock mechanism operated by a programmable key has the advantage that each, more than one, or all of the security devices and their corresponding keys can be programmed to transmit and/or receive an energy signal for arming and disarming an alarm. The energy signal may be generated by an electrical, optical, acoustical or magnetic source, and is generically referred to herein as a Security Disarm Code (SDC). The SDC is predetermined by the manufacturer of the security device, or alternatively, may be selected by the retailer at a particular retail location. Preferably, the SDC is randomly generated and unknown to all persons, or alternatively, is made known only to authorized persons. Accordingly, an unauthorized person without access to the SDC or means to determine the SDC cannot program a duplicate key with the same SDC. Furthermore, most programmable keys and security devices can be readily reprogrammed by the retailer with a different SDC in the event that one of the programmable keys is lost or stolen. As previously mentioned, the replacement keys and security devices preferably are programmed with a randomly generated SDC that is unique and unknown to any individual.

A known disadvantage of an electronic lock mechanism in the form of a sensor monitoring circuit operated by a programmable key is that the lock mechanism does not physically attach the security device to the support. Instead, the lock mechanism merely arms and disarms an alarm, for example an audible alarm operatively coupled to the sensor monitoring circuit, that is activated in the event the item of merchandise is removed from the security device or the security device is detached from the support. As a result, a shoplifter may physically remove the item of merchandise from the security device, or alternatively, detach the security device from the support, and then attempt to leave the display area before security personnel are able to respond to the alarm. Another known disadvantage is that store personnel are primarily occupied with selling and re-stocking the items of merchandise. Consequently, store personnel often fail to arm the security devices and neglect to re-arm a security device that has been disarmed for any reason. Another known disadvantage encountered with a security device operated by a programmable key is that the security device may be inoperable in the event of a power outage, battery discharge, or other electrical failure. A further disadvantage is that the arming and disarming function of a security device operated by a programmable key is susceptible to being replicated by a counterfeit energy signal generated by a device other than an authentic key.

No known merchandise security device exists that combines the advantages of a mechanical lock mechanism operated by a non-programmable key with the advantages of an electronic lock mechanism operated by a programmable key, while avoiding the disadvantages of both non-programmable and programmable keys. More specifically, no known merchandise security device provides both a mechanical lock mechanism for physically attaching a security device to a support and an electronic lock mechanism that responds to an energy signal to arm and disarm an alarm, or alternatively, to lock and unlock the security device. Consequently, no known programmable key exists for operating a security device that utilizes both a mechanical lock mechanism and an electronic lock mechanism. Heretofore, manufacturers of merchandise security devices, as well as retailers, have not recognized the synergistic advantages provided by a security device that utilizes both a mechanical lock mechanism and an electronic lock mechanism operated by a single programmable key. Specifically, such a security device combines the structural integrity provided by a mechanical lock mechanism that physically attaches the security device to a support with the additional security and reduced replacement cost provided by an electronic lock mechanism operated by a programmable key that arms and disarms an alarm.

Accordingly, there exists an unresolved need for a programmable key for operating a merchandise security device having both a mechanical lock mechanism for physically attaching and detaching the security device from a support and an electronic lock mechanism for arming and disarming an alarm, or alternatively, for activating the mechanical lock mechanism to lock and unlock the security device. There exists a more specific need for a programmable key for transferring power, and more preferably, both data and power, to a merchandise security device.

### BRIEF DESCRIPTION OF THE DRAWINGS

The detailed description of the invention provided below may be better understood with reference to the accompanying drawing figures, which depict one or more exemplary embodiments of an electronic key for use with a merchandise security device in a merchandise display security system and method according to the invention.

FIG. 1A shows an exemplary embodiment of a merchandise display security system and method including a programmable electronic key, a merchandise security device, a programming station and a charging station according to the invention.

FIG. 1B is an enlarged view showing the programmable electronic key of FIG. 1A positioned on the programming station of FIG. 1A to be programmed with a security code.

FIG. 2 further shows the system and method of FIG. 1A with the programmable electronic key positioned to operate the merchandise security device.

FIG. 3A further shows the system and method of FIG. 1A with the programmable electronic key disposed on the charging station.

FIG. 3B is an enlarged view showing the programmable electronic key of FIG. 1A positioned on the charging station of FIG. 1A to recharge a power source disposed within the key.

FIG. 4 is an enlarged view showing the merchandise security device of the system and method of FIG. 1A.

FIG. 5 is an enlarged view showing the programmable electronic key of the system and method of FIG. 1A in greater detail.

FIG. 6 is an exploded view of the programmable electronic key of FIG. 5.

FIG. 7A is a perspective view of the programmable electronic key of FIG. 5.

FIG. 7B is an end view of the programmable electronic key of FIG. 5.

FIG. 8 is a perspective view showing a lengthwise cross-section of the programmable electronic key of FIG. 5.

FIG. 9A is a top view showing the charging station of the system and method of FIG. 1A.

FIG. 9B is a perspective view showing a diagonal cross-section of the charging station of FIG. 9A taken along the line 9B-9B.

FIG. 10 shows another exemplary embodiment of a merchandise display security system and method including a programmable electronic key, a merchandise security device, a programming station and a charging station according to the invention.

FIG. 11 is an enlarged view showing the programmable electronic key of FIG. 10 positioned on the charging station of FIG. 10 to recharge a power source disposed within the key.

FIG. 12 is an enlarged view showing the merchandise security device of the system and method of FIG. 10.

FIG. 13 is an enlarged view showing the programmable electronic key of the system and method of FIG. 10 in greater detail.

FIG. 14 is a perspective view showing a pair of matched coils for use with the programmable electronic key and the merchandise security device of FIG. 10.

FIG. 15A is a perspective view of the programmable electronic key of FIG. 13.

FIG. 15B is an end view of the programmable electronic key of FIG. 13.

FIG. 16 is a perspective view showing a lengthwise cross-section of the programmable electronic key of FIG. 13.

FIG. 17A is a top view showing the charging station of the system and method of FIG. 10.

FIG. 17B is a perspective view showing a diagonal cross-section of the charging station of FIG. 17A taken along the line 17B-17B.

### DETAILED DESCRIPTION OF EMBODIMENTS OF THE INVENTION

Referring now to the accompanying drawing figures wherein like reference numerals denote like elements throughout the various views, one or more exemplary embodiments of a merchandise display security system and method are shown. In the exemplary embodiments shown and described herein, the system and method include a programmable electronic key, indicated generally at 20, 120 and a merchandise security device, indicated generally at 40, 140. Merchandise security devices 40, 140 suitable for use with the programmable electronic keys 20, 120 include, but are not limited to, a security display (e.g. alarming stand), security fixture (e.g. locking hook, shelf, cabinet, etc.) or security packaging (e.g. merchandise keeper) for an item of merchandise. However, a programmable electronic key (also referred to herein as a merchandise security key) according to the invention is useable with any security device or locking device that utilizes power transferred from the key to operate a mechanical lock mechanism and/or utilizes data transferred from the key to authorize the operation of an electronic lock mechanism, such as an alarm circuit. In other words, a programmable electronic key according to the invention is useable with any security device or locking device that requires power transferred from the key to the device and/or data transferred from the key to the device. Further examples of security devices and locking devices include, but are not limited to, a door lock, a drawer lock or a shelf lock, as well as any device that prevents an unauthorized person from accessing, removing or detaching an item from a secure location or position. It should be noted that although the invention is described with respect to exemplary embodiments including a programmable electronic key for transferring data and electrical power to a merchandise security device to operate a mechanical lock mechanism, the invention is equally applicable to an electronic key for transferring only electrical power to a merchandise security device to operate any component of the merchandise security device, whether or not the device includes an internal or external power source for operating another component of the device.

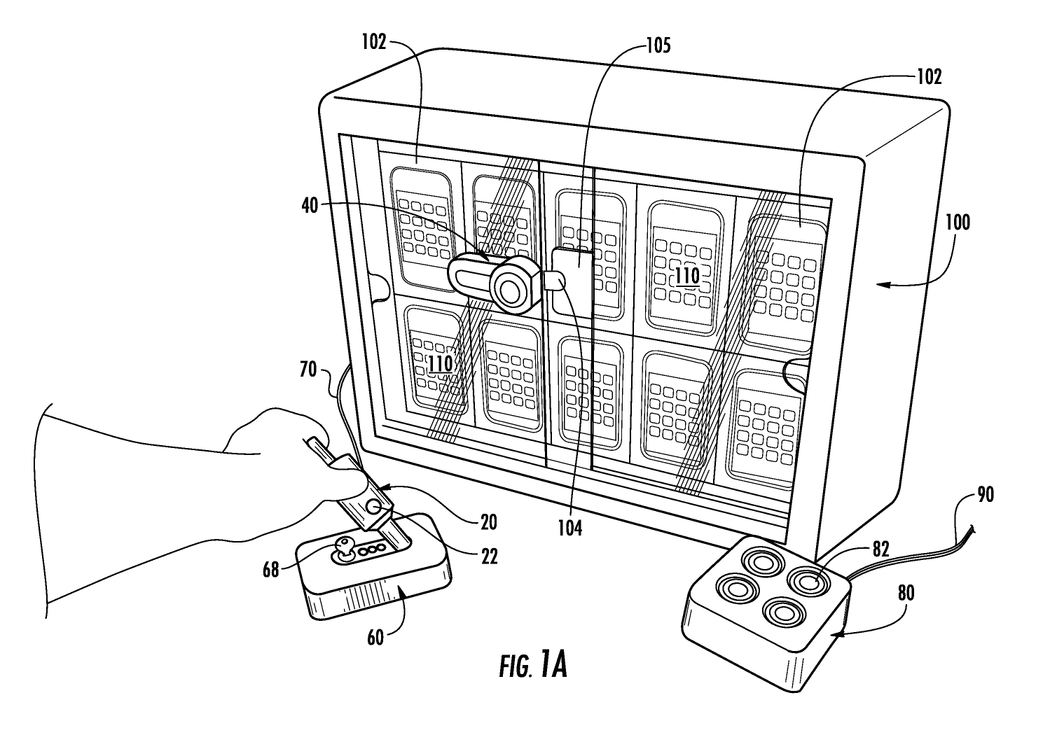

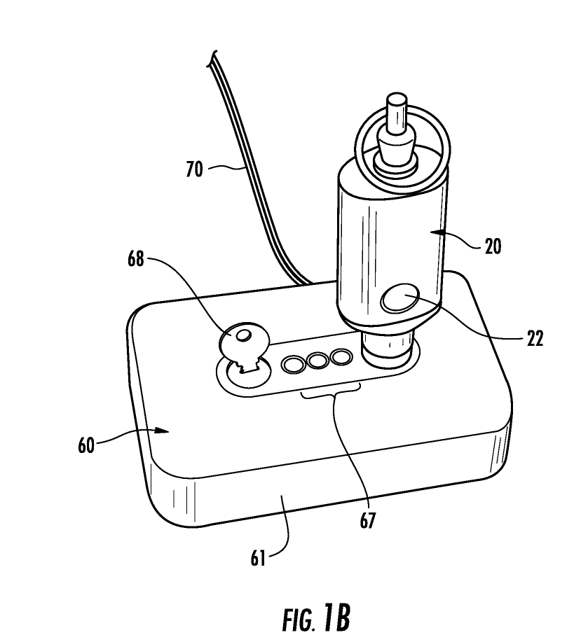

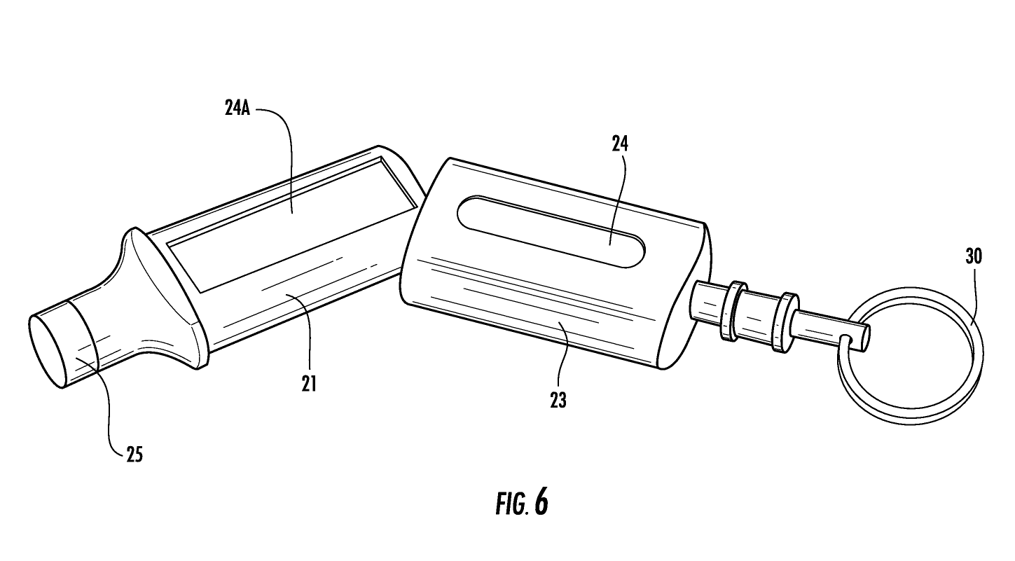

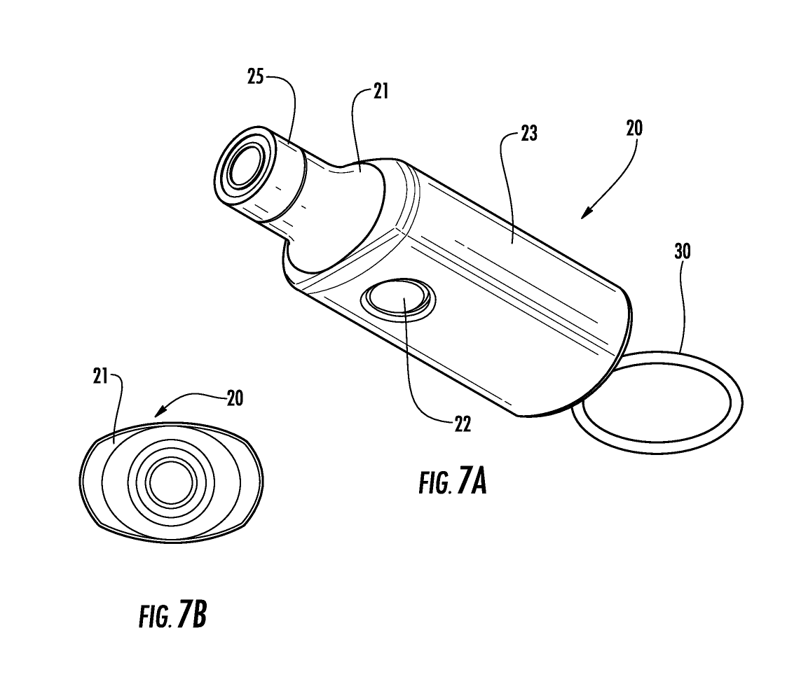

An exemplary embodiment of a merchandise display system and method according to the invention is illustrated in FIGS. 1A-9B. The embodiment of the merchandise display security system and method depicted comprises a programmable electronic key 20, which is also referred to herein as a merchandise security key, and a merchandise security device 40 that is configured to be operated by the key. The system and method may further comprise an optional programming station, indicated generally at 60, that is operable for programming the key 20 with a security code, which is also referred to herein as a Security Disarm Code (SDC). In addition to programming station 60, the system and method may further comprise an optional charging station, indicated generally at 80, that is operable for initially charging and/or subsequently recharging a power source disposed within the key 20. For example, merchandise security key 20 and merchandise security device 40 may each be programmed with the same SDC into a respective permanent memory. The merchandise security key 20 may be provisioned with a single-use (i.e. non-rechargeable) power source, such as a conventional or extended-life battery, or alternatively, the key may be provisioned with a multiple-use (i.e. rechargeable) power source, such as a conventional capacitor or rechargeable battery. In either instance, the power source may be permanent, semi-permanent (i.e. replaceable), or rechargeable, as desired. In the latter instance, charging station 80 is provided to initially charge and/or to subsequently recharge the power source provided within the merchandise security key 20. Furthermore, key 20 and/or merchandise security device 40 may be provided with only a transient memory, such that the SDC must be programmed (or reprogrammed) at predetermined time intervals. In this instance, programming station 60 is provided to initially program and/or to subsequently reprogram the SDC into the key 20. As will be described, key 20 is operable to initially program and/or to subsequently reprogram the merchandise security device 40 with the SDC. Key 20 is then further operable to operate the merchandise security device 40 by transferring power and/or data to the device, as will be described.

In the exemplary embodiment of the system and method illustrated in FIGS. 1A-9B, programmable electronic key 20 is configured to be programmed with a unique SDC by the programming station 60. A programming station 60 suitable for use with the present invention is shown and described in detail in the commonly owned U.S. Pat. No. 7,737,844 entitled PROGRAMMING STATION FOR A SECURITY SYSTEM FOR PROTECTING MERCHANDISE, the disclosure of which is incorporated herein by reference in its entirety. As illustrated in FIG. 1A and best shown in enlarged FIG. 1B, the key 20 is presented to the programming station 60 and communication therebetween is initiated, for example by pressing a control button 22 provided on the exterior of the key. Communication between the programming station 60 and the key may be accomplished directly, for example by one or more electrical contacts, or indirectly, for example by wireless communication. Any form of wireless communication capable of transferring data between the programming station 60 and key 20 is also possible, including without limitation optical transmission, acoustic transmission or magnetic induction. In the exemplary embodiments shown and described herein, communication between programming station 60 and key 20 is accomplished by wireless optical transmission, and more particularly, by cooperating infrared (IR) transceivers provided in the programming station and the key. The components and method of IR communication between programming station 60 and key 20 is described in greater detail in the aforementioned U.S. Pat. No. 7,737,844, and accordingly, will not be repeated here. For the purpose of describing the present invention, it is sufficient that the programming station comprises at least a logic control circuit for generating or being provided with a SDC, a memory for storing the SDC, and a communications system suitable for interacting with the programmable electronic key 20 in the manner described herein to program the key with the SDC.

As shown in FIG. 1B, programming station 60 comprises a housing 61 configured to contain the logic control circuit that generates the SDC, the memory that stores the SDC, and a communications system, namely an optical transceiver, for wirelessly communicating the SDC to a cooperating optical transceiver disposed within the key 20. In use, the logic control circuit generates the SDC, which may be a predetermined (i.e. “factory preset”) security code, or which may be a security code that is randomly generated by the logic control circuit of the programming station 60 at the time a first key 20 is presented to the station for programming. In the latter instance, the logic control circuit further comprises a random number generator for producing the unique SDC. A series of visual indicators, for example light-emitting diodes (LEDs) 67 may be provided on the exterior of the housing 61 for indicating the operating status of the programming station. Programming station 60 may further be provided with a mechanical lock mechanism, for example a conventional key and tumbler lock 68, for preventing use of the programming station by an unauthorized person. Alternatively, the programming station 60 may be maintained within a locked enclosure to prevent access by an unauthorized person. As shown herein, the programming station 60 may be operatively connected to an external power source by a power cord 70 having at least one conductor. Alternatively, the programming station 60 may comprise an internal power source, for example an extended-life replaceable battery or a rechargeable battery, for providing power to the logic control circuit and the LEDs 67.

In a particular embodiment, the logic control circuit of the programming station 60 performs an electronic exchange of data with a logic control circuit of the key 20, commonly referred to as a “handshake communication protocol.” The handshake communication protocol determines whether the key is an authorized key that has not been programmed previously (i.e. a “new” key), or is an authorized key that is being presented to the programming station a subsequent time to refresh the SDC. In the event that the handshake communication protocol fails, the programming station 60 will not provide the SDC to the unauthorized device attempting to obtain the SDC, for example an infrared reader on a counterfeit key. When the handshake communication protocol succeeds, programming station 60 permits the SDC randomly generated by the logic control circuit and/or stored in the memory of the station to be transmitted by the optical transceiver to the cooperating optical transceiver disposed within the key 20. As will be readily apparent to those skilled in the art, the SDC may be transmitted from the programming station 60 to the merchandise security key 20 alternatively by any other suitable means, including without limitation, electrical contacts or electromechanical, electromagnetic or magnetic conductors, as desired.

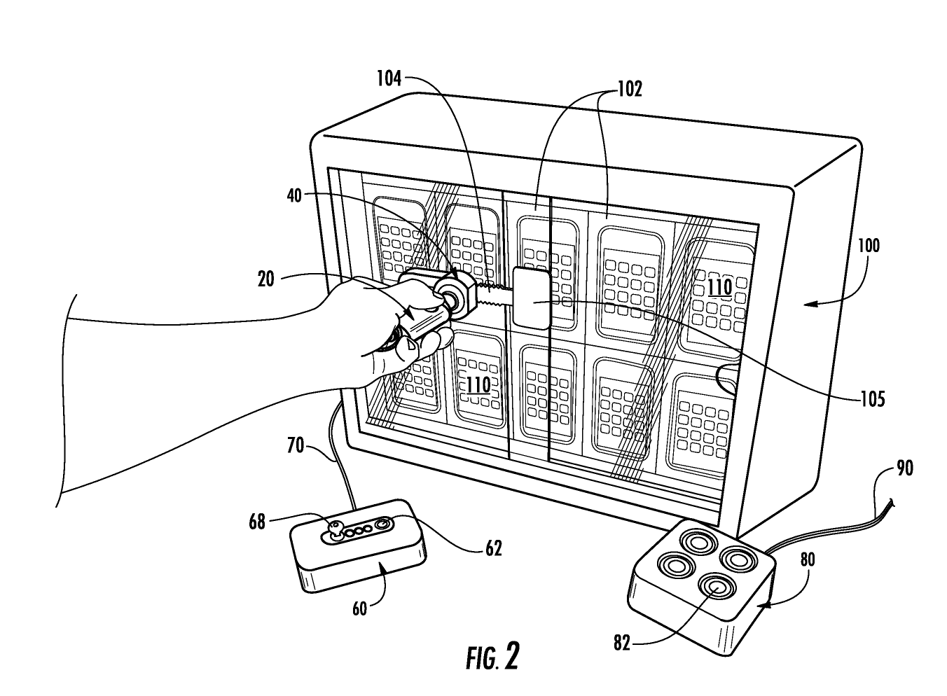

As illustrated in FIG. 2, the merchandise security key 20 programmed with the SDC is then positioned to operatively engage the merchandise security device 40. In the embodiments shown and described herein, the merchandise security device is a conventional cabinet lock that has been modified to be unlocked by the programmable electronic key 20. Preferably, the merchandise security device 40 is a “passive” device. As used herein, the term passive is intended to mean that the security device 40 does not have an internal power source sufficient to lock and/or unlock a mechanical lock mechanism. Significant cost savings are obtained by a retailer when the merchandise security device 40 is passive since the expense of an internal power source is confined to the merchandise security key 20, and one such key is able to operate multiple security devices. If desired, the merchandise security device 40 may also be provided with a temporary power source (e.g., capacitor or limited-life battery) having sufficient power to activate an alarm, for example a piezoelectric audible alarm, that is actuated by a sensor, for example a contact, proximity or limit switch, in response to a security breach. The temporary power source may also be sufficient to communicate data, for example a SDC, from the merchandise security device 40 to the merchandise security key 20 to authenticate the security device and thereby authorize the key to provide power to the security device. Prior to the present invention, mechanical lock mechanisms were operated, for example, by a conventional key or by a magnetic key of the type shown and described in the commonly owned United States Patent Application Publication No. 2008/0168811 entitled MAGNETIC KEY FOR USE WITH A SECURITY DEVICE, the disclosure of which is incorporated herein by reference in its entirety. With this embodiment of the present invention, however, the mechanical lock mechanism is operated by electrical power that is transferred from the key 20 to the security device 40 via electrical contacts, as will be described.

The merchandise security device 40 further comprises a logic control circuit, similar to the logic control circuit disposed within the key 20, adapted to perform a handshake communication protocol with the logic control circuit of the key in essentially the same manner as that between the programming station 60 and the key. In essence, the logic control circuit of the key 20 and the logic control circuit of the merchandise security device 40 communicate with each other to determine whether the merchandise security device is an authorized device that does not have a security code, or is a device having a proper (i.e. matching) SDC. In the event the handshake communication protocol fails (e.g. the device is not authorized or the device has a non-matching SDC), the key 20 will not program the device 40 with the SDC, and consequently, the merchandise security device will not operate. If the merchandise security device 40 was previously programmed with a different SDC, the device will no longer communicate with the merchandise security key 20. In the event the handshake communication protocol is successful, the merchandise security key 20 permits the SDC stored in the key to be transmitted by the optical transceiver disposed within the key to a cooperating optical transceiver disposed within the merchandise security device 40 to program the device with the SDC. As will be readily apparent to those skilled in the art, the SDC may be transmitted from the merchandise security key 20 to the merchandise security device 40 alternatively by any other suitable means, including without limitation, via one or more electrical contacts, or via electromechanical, electromagnetic or magnetic conductors, as desired. Furthermore, the SDC may be transmitted by inductive transfer of data from the programmable electronic key 20 to the programmable merchandise security device 40.

On the other hand, when the handshake communication protocol is successful and the merchandise security device 40 is an authorized device having the same (i.e. matching) SDC, the logic control circuit of the key 20 causes the internal power source of the key to transfer electrical power to the device to operate the mechanical lock mechanism. In the exemplary embodiment of FIGS. 1A-9B, electrical contacts disposed on the merchandise security key 20 electrically couple with cooperating electrical contacts on the merchandise security device 40 to transfer power from the internal battery of the key to the merchandise security device. Power may be transferred directly to the mechanical lock mechanism, or alternatively, may be transferred to a power circuit disposed within the merchandise security device 40 that operates the mechanical lock mechanism of the security device. In the embodiment of FIGS. 1A-9B, the cabinet lock 40 is affixed to one of the pair of adjacent and overlapping sliding doors 102 of a conventional merchandise display cabinet 100 of the type suitable for use, for example, in a retail store. The cabinet 100 typically contains relatively expensive items of merchandise 110, such as cellular (mobile) telephones, digital cameras, Global Positioning Satellite (GPS) devices, and the like. The doors 102 overlap medially between the ends of the cabinet 100 and the cabinet lock 40 is secured on an elongate locking arm 104 of a lock bracket 105 affixed to the inner door. In the illustrated example, the key 20 transfers power to an electric motor, such as a DC stepper motor, solenoid, or the like, that unlocks the lock mechanism of the cabinet lock 40 so that the cabinet lock can be removed from the arm 104 of the bracket 105 and the doors moved (i.e. slid) relative to one another to access the items of merchandise 110 stored within the cabinet 100. As shown, the arm 104 of the bracket 105 is provided with one-way ratchet teeth 106 and the cabinet lock 40 is provided with a complimentary ratchet pawls (not shown) in a conventional manner so that the key 20 is not required to lock the cabinet lock 40 onto the inner door 102 of the cabinet 100. If desired, however, the cabinet lock 40 can be configured to require use of the key 20 to both unlock and lock the cabinet lock.

It will be readily apparent to those skilled in the art that the cabinet lock illustrated herein is but one of numerous types of passive merchandise security devices 40 that can be configured to be operated by a programmable electronic key 20 according to the present invention. By way of example and without limitation, merchandise security device 40 may be a locking base for securing a merchandise display hook to a display support, such as pegboard, slatwall, bar stock or wire grid, or may be a locking end assembly for preventing the rapid removal of merchandise from the merchandise display hook. Alternatively, the merchandise security device 40 may be a merchandise security display stand comprising a mechanical lock mechanism for securing the display stand to a display support, such as a table, counter, desk, wall, or other support. Alternatively, the merchandise security device 40 may be incorporated into packaging for one or more items of merchandise comprising a mechanical lock mechanism for separating the packaging from the merchandise or for removing the merchandise from the packaging. Still further, the merchandise security device 40 may be a conventional door or window lock for preventing access to a room, booth, box or other enclosure. In any of the aforementioned embodiments, the merchandise security device 40 may further comprise an electronic lock mechanism, such as a conventional proximity, limit or contact switch, including an associated monitoring circuit that activates an alarm in response to the switch being actuated or the integrity of a sense loop monitored by the monitoring circuit being compromised. In such embodiments the merchandise security device 40 comprises a logic control circuit, or the equivalent, including a memory for storing a SDC, and a communication system for initially receiving the SDC from the merchandise security key 20 and subsequently communicating with the key to authenticate the SDC of the key.

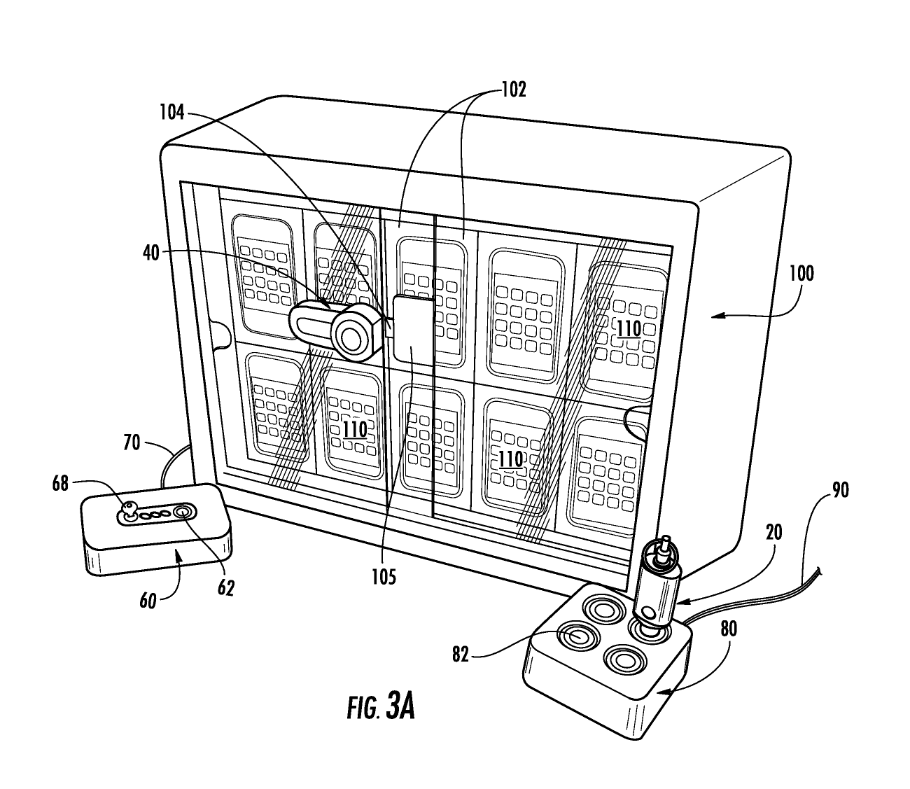

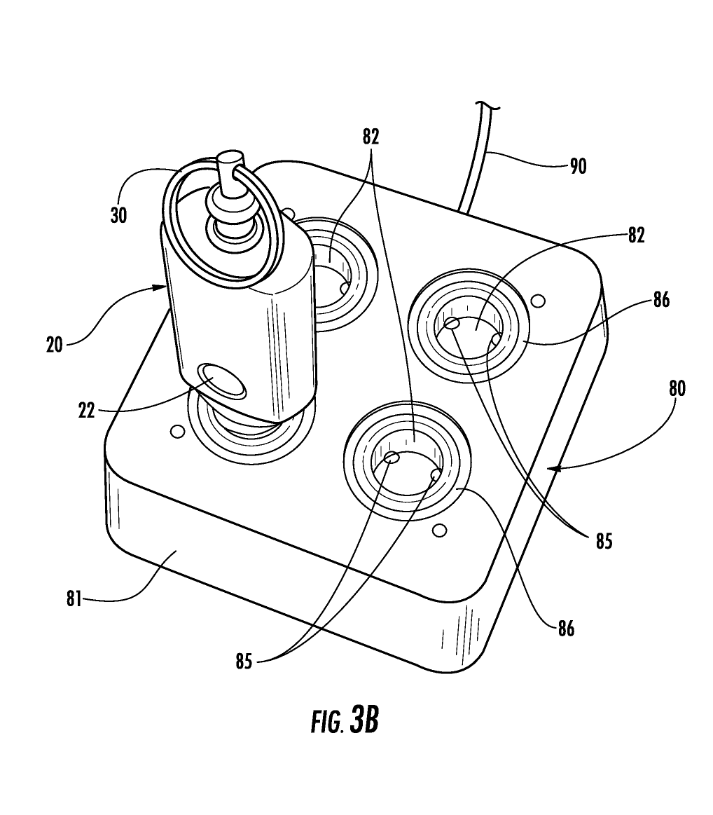

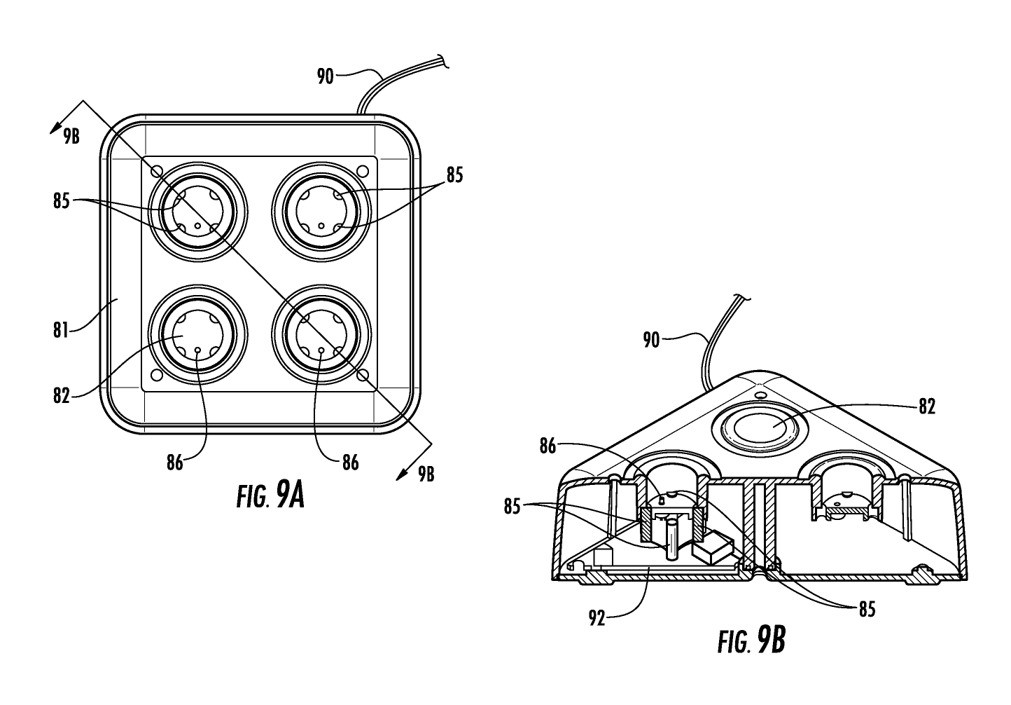

As illustrated in FIG. 3A and shown enlarged in FIG. 3B, the merchandise security system and method further comprises charging station 80 for initially charging and subsequently recharging a rechargeable battery disposed within the merchandise security key 20. The charging station 80 comprises at least one, and preferably, a plurality of charging ports 82 each sized and shaped to receive a key 20 to be charged or recharged. As will be described in greater detail with reference to FIGS. 9A and 9B, each charging port 82 comprises at least one, and preferably, a plurality of magnets 85 for securely positioning and retaining the key 20 within the charging port 82 in electrical contact with the charging station 80. If desired, the charging station 80 may comprise an internal power source, for example, an extended-life replaceable battery or a rechargeable battery, for providing power to up to four keys 20 positioned within respective charging ports 82. Alternatively, and as shown herein, charging station 80 may be operatively connected to an external power source by a power cord 90 having at least one conductor.

An available feature of a merchandise security system and method according to the invention is that the logic control circuit of the programmable electronic key 20 may include a time-out function. More particularly, the ability of the key 20 to transfer data and power to the merchandise security device 40 is deactivated after a predetermined time period. By way of example, the logic control circuit may be deactivated after about eight hours from the time the key was programmed or last refreshed by the programming station 60. In this manner, an authorized sales associate typically must program or refresh the key 20 assigned to him at the beginning of each work shift. Furthermore, the charging station 80 may be configured to deactivate the logic control circuit of the key 20 (and thereby prevent use of the SDC) when the key is positioned within a charging port 82. In this manner, the charging station 80 can be made available to an authorized sales associate in an unsecured location without risk that a charged key 20 could be removed from the charging station and used to maliciously disarm and/or unlock a merchandise security device 40. The merchandise security key 20 would then have to be programmed or refreshed with the SDC by the programming station 60, which is typically monitored or maintained at a secure location, in order to reactivate the logic control circuit of the key. If desired, the charging station 80 may alternatively require a matching handshake communication protocol with the programmable electronic key 20 in the same manner as the merchandise security device 40 and the key.

FIG. 4 is an enlarged view showing the exemplary embodiment of the merchandise security device 40 in greater detail. As previously mentioned, a merchandise security device 40 according to the present invention may be any type of security device including, but not limited to, a security display (e.g. alarming stand), security fixture (e.g. locking hook, shelf, cabinet, etc.), security packaging (e.g. merchandise keeper for items of merchandise) or a conventional door/window/drawer lock; etc.), that utilizes electrical power to lock and/or unlock a mechanical lock mechanism, and optionally, further includes an electronic lock mechanism, such as an alarm or a security “handshake.” At the same time, the merchandise security device 40 must be a passive device in the sense that it does not have an internal power source sufficient to operate the mechanical lock mechanism. As a result, the merchandise security device 40 must be configured to receive at least power, and preferably, both power and data from an external source, such as the merchandise security key 20 shown and described herein. The exemplary embodiment of the merchandise security device depicted in FIG. 4 is a cabinet lock 40 configured to be securely affixed to the locking arm 104 of a conventional cabinet lock bracket 105, as previously described. The cabinet lock 40 comprises a logic control circuit for performing a security handshake communication protocol with the logic control circuit of the merchandise security key 20 and for being programmed with the SDC by the key. In other embodiments, the cabinet lock 40 may be configured to transmit the SDC to the merchandise security key 20 to authenticate the security device and thereby authorize the key to transfer power to the cabinet lock. As previously mentioned, the data (e.g. handshake communication protocol and SDC) may be transferred (i.e. transmitted and received) by electrical contacts, optical transmission, acoustic transmission or magnetic induction, for example.

The cabinet lock 40 comprises a housing 41 sized and shaped to contain a logic control circuit (not shown) and an internal mechanical lock mechanism (not shown). A transfer port 42 formed in the housing 41 is sized and shaped to receive a transfer probe of the merchandise security key 20, as will be described. At least one, and preferably, a plurality of magnets 45 are disposed within the transfer port 42 for securely positioning and retaining the transfer probe of the key 20 in electrical contact with electrical contacts of the mechanical lock mechanism, and if desired, in electrical contact with the logic control circuit of the cabinet lock 40. In the exemplary embodiment shown and described in FIGS. 1A-9B, data is transferred from the merchandise security key 20 to the cabinet lock 40 by wireless communication, such as by infrared (IR) optical transmission, as shown and described in the commonly owned U.S. Pat. No. 7,737,843 entitled PROGRAMMABLE ALARM MODULE AND SYSTEM FOR PROTECTING MERCHANDISE, the disclosure of which is incorporated herein by reference in its entirety. Power is transferred from the merchandise security key 20 to the cabinet lock 40 through electrical contacts disposed on the transfer probe of the key and corresponding electrical contacts disposed within the transfer port 42 of the cabinet lock. For example, the transfer port 42 may comprise a metallic outer ring 46 that forms one electrical contact, while at least one of the magnets 45 form another electrical contact to complete an electrical circuit with the electrical contacts disposed on the transfer probe of the key 20. Regardless, electrical contacts transfer power from the key 20 to the mechanical lock mechanism disposed within the housing 41. As previously mentioned, the power transferred from the key 20 is used to operate the mechanical lock mechanism, for example utilizing an electric motor, DC stepper motor, solenoid, or the like, to unlock the mechanism so that the cabinet lock 40 can be removed from the locking arm 104 of the lock bracket 105.

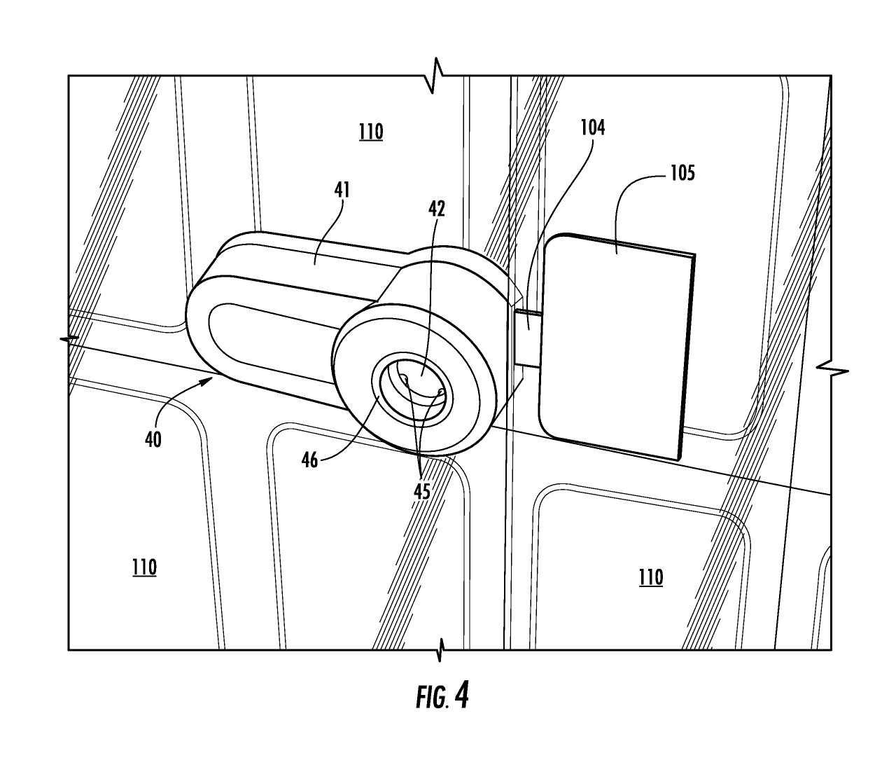

FIGS. 5-8 show an exemplary embodiment of a merchandise security key, also referred to herein as a programmable electronic key, 20 according to the present invention. As previously mentioned, the merchandise security key 20 is configured to transfer both data and power to a merchandise security device 40 that comprises an electronic lock mechanism and a mechanical lock mechanism, as previously described. Accordingly, the programmable electronic key 20 must be an “active” device in the sense that it has an internal power source sufficient to operate the mechanical lock mechanism of the merchandise security device 40. As a result, the programmable electronic key 20 may be configured to transfer both data and power from an internal source disposed within the key, for example a logic control circuit (i.e. data) and a battery (i.e. power). The exemplary embodiment of the programmable electronic key 20 depicted in FIGS. 5-8 is a merchandise security key configured to be received within the transfer port 42 of the cabinet lock 40 shown in FIG. 4, as well as within the programming port 62 of the programming station 60 (FIG. 2; FIG. 3A) and the charging port 82 of the charging station 80 (FIG. 3B; FIG. 9A; FIG. 9B). The programmable electronic key 20 comprises a logic control circuit for performing a handshake communication protocol with the logic control circuit of the programming station 60 and for receiving the SDC from the programming station, as previously described. The logic control circuit of the programmable electronic key 20 further performs a handshake communication protocol with the logic control circuit of the merchandise security device 40 and transfers the SDC to the device or permits operation of the device, as previously described. As previously mentioned, the data (e.g. handshake communication protocol and SDC) may be transferred (i.e. transmitted and received) by direct electrical contacts, optical transmission, acoustic transmission or magnetic induction.

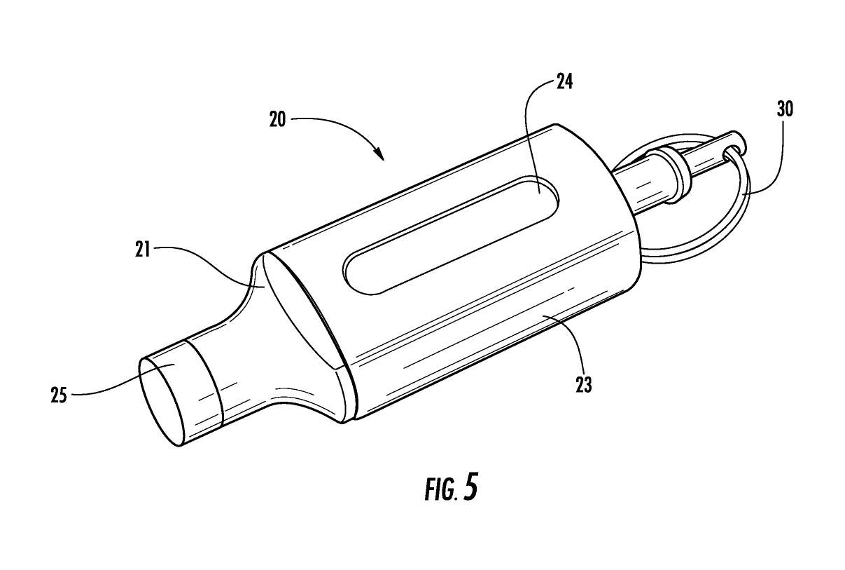

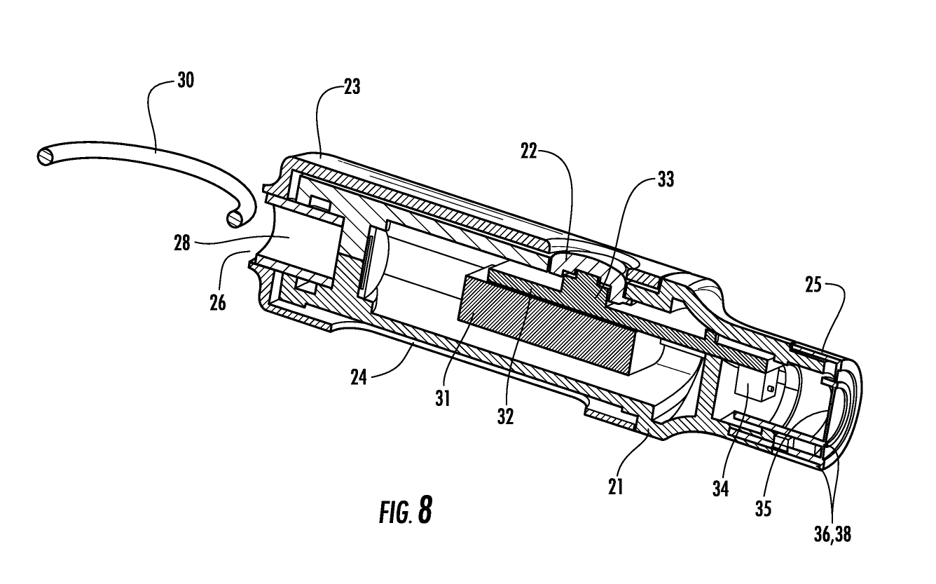

As illustrated in FIG. 6, the programmable electronic key 20 comprises a housing 21 and an outer sleeve 23 that is removably disposed on the housing. The housing 21 contains the internal components of the key 20, including without limitation the logic control circuit, memory, communication system and battery, as will be described. A window 24 may be formed through the outer sleeve 23 for viewing indicia 24A that uniquely identifies the key 20, or alternatively, indicates a particular item of merchandise, a specific merchandise security device, or a display area within a retail store for use with the key. The outer sleeve 23 is removably disposed on the housing 21 so that the indicia 24A may be altered or removed and replaced with different indicia. The programmable electronic key 20 may further comprise a detachable “quick-release” type key chain ring 30. An opening 26 (FIG. 8) is formed through the outer sleeve 23 and a key chain ring port 28 is formed in the housing 21 for receiving the key chain ring 30. The programmable electronic key 20 further comprises a transfer probe 25 located at an end of the housing 21 opposite the key chain ring port 28 for transferring data and power to the merchandise security device 40, as previously described. The transfer probe 25 also transmits and receives the handshake communication protocol and the SDC from the programming station 60, as previously described, and receives power from the charging station 80, as will be described in greater detail with reference to FIG. 9A and FIG. 9B.

As best shown in FIG. 8, an internal battery 31 and a logic control circuit, or printed circuit board (PCB) 32 are disposed within the housing 21 of the programmable electronic key 20. Battery 31 may be a conventional extended-life replaceable battery, but preferably, is a rechargeable battery suitable for use with the charging station 80. The logic control circuit 32 is operatively coupled and electrically connected to a switch 33 that is actuated by the control button 22 provided on the exterior of the key 20 through the outer sleeve 23. Control button 22 in conjunction with switch 33 controls certain operations of the logic control circuit 32, and in particular, transmission of the data (i.e. handshake communication protocol and SDC) to the merchandise security device 40. In that regard, the logic control circuit 32 is further operatively coupled and electrically connected to a communication system 34 for transmitting and receiving the handshake communication protocol and SDC data. In the exemplary embodiment shown and described herein, the communication system 34 is a wireless infrared (IR) transceiver for optical transmission of data between the programmable electronic key 20 and the programming station 60, as well as between the key 20 and the merchandise security device 40. As a result, the transfer probe 25 of the key 20 is provided with an optically transparent or translucent filter window 35 for emitting and collecting optical transmissions between the key 20 and the programming station 60, or alternatively, between the key 20 and the merchandise security device 40, as required. Transfer probe 25 further comprises a pair of bi-directional power transfer electrical contacts 36, 38 made of an electrically conductive material for transferring power to the merchandise security device 40 and for receiving power from the charging station 80, as required. Accordingly, electrical contacts 36, 38 are electrically connected to battery 31, and are operatively coupled and electrically connected to logic control circuit 32 in any suitable manner, for example by conductive insulated wires or plated conductors.

An important aspect of a programmable electronic key 20 according to the present invention, especially when used for use in conjunction with a merchandise security device 40 as described herein, is that the key does not require a physical force to be exerted by a user on the key to operate the mechanical lock mechanism of the merchandise security device. By extension, no physical force is exerted by the key on the mechanical lock mechanism. As a result, the key cannot be unintentionally broken off in the lock, as often occurs with conventional mechanical key and lock mechanisms. Furthermore, neither the key nor and the mechanical lock mechanism suffer from excessive wear as likewise often occurs with conventional mechanical key and lock mechanisms. In addition, there is no required orientation of the transfer probe 25 of the programmable electronic key 20 relative to the charging port 82 of the charging station 80 or the transfer port 42 of the merchandise security device 40. Accordingly, any wear of the electrical contacts on the transfer probe 25, the charging port 82 or the transfer port 42 is minimized. As a further advantage, an authorized person is not required to position the transfer probe 25 of the programmable electronic key 20 in a particular orientation relative to the transfer port 42 of the merchandise security device 40 and thereafter exert a compressive and/or torsional force on the key to operate the mechanical lock mechanism of the device.

FIG. 9A and FIG. 9B show charging station 80 in greater detail. As previously mentioned, the charging station 80 recharges the internal battery 31 of the programmable electronic key 20, and if desired, deactivates the data transfer and/or power transfer capability of the key until the key is reprogrammed with the SDC by the programming station 60. Regardless, the charging station 80 comprises a housing 81 for containing the internal components of the charging station. The exterior of the housing 81 has at least one, and preferably, a plurality of charging ports 82 formed therein that are sized and shaped to receive the transfer probe 25 of the merchandise security key 20, as previously described. At least one, and more preferably, a plurality of magnets 85 are disposed within each charging port 82 for securely positioning and retaining the transfer probe 25 in electrical contact with the charging station 80. More particularly, the electrical contacts 36, 38 of the key 20 are retained within the charging port 82 in electrical contact with the magnets 85 and a resilient “pogo” pin 86 made of a conductive material to complete an electrical circuit between the charging station 80 and the battery 31 of the key.

As best shown in FIG. 9B, housing 81 is sized and shaped to contain a logic control circuit, or printed circuit board (PCB) 92 that is operatively coupled and electrically connected to the magnets 85 and the pogo pin 86 of each charging port 82. The pogo pin 86 is depressible to complete an electrical circuit as the magnets 85 position and retain the electrical contacts 36, 38 within the charging port 82. In particular, magnets 85 make electrical contact with the outer ring electrical contact 36 of the transfer probe 25 of key 20, while pogo pin 86 makes electrical contact with inner ring electrical contact 38 of the transfer probe. When the pogo pin 86 is depressed and the electrical circuit between the charging station 80 and the key 20 is completed, the charging station recharges the internal battery 31 of the key. As previously mentioned, charging station 80 may comprise an internal power source, for example, an extended-life replaceable battery or a rechargeable battery, for providing power to the key(s) 20 positioned within the charging port(s) 82. Alternatively, and as shown herein, the logic control circuit 92 of the charging station 80 is electrically connected to an external power source by a power cord 90 having at least one conductor. Furthermore, logic control circuit 92 may be operable for deactivating the data transfer and power transfer functions of the programmable electronic key 20, or alternatively, for activating the “time-out” feature of the key until it is reprogrammed or refreshed by the programming station 60.

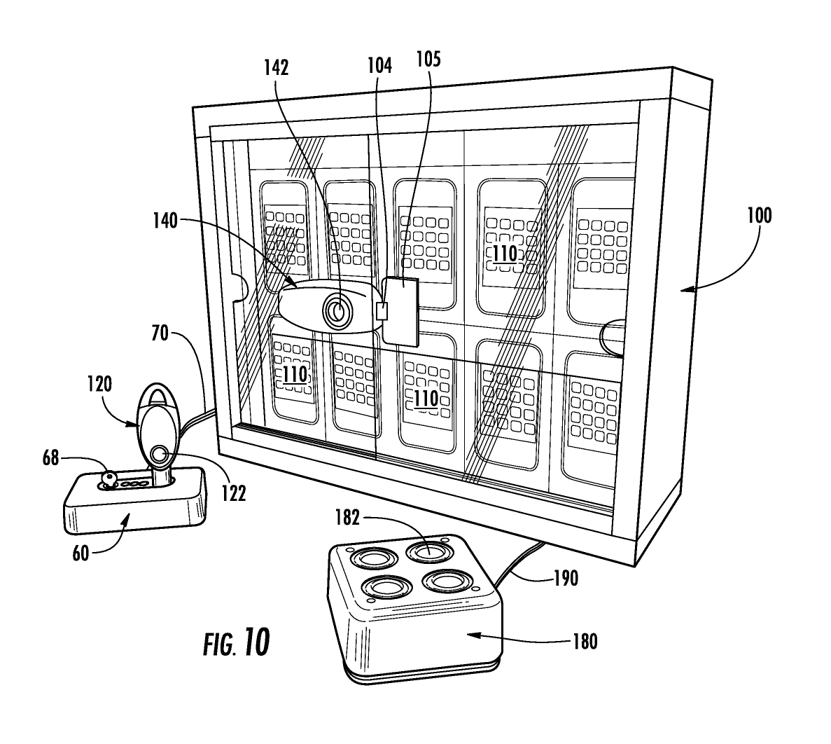

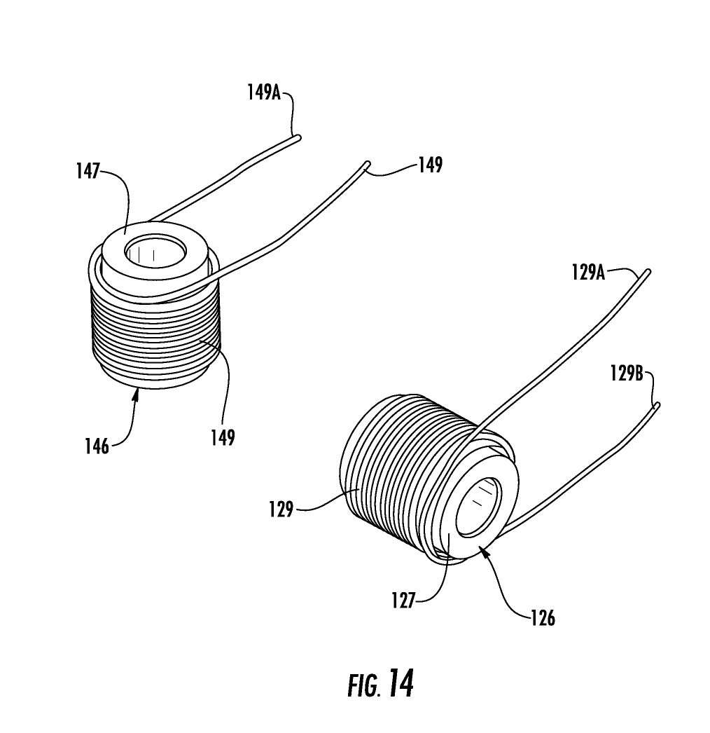

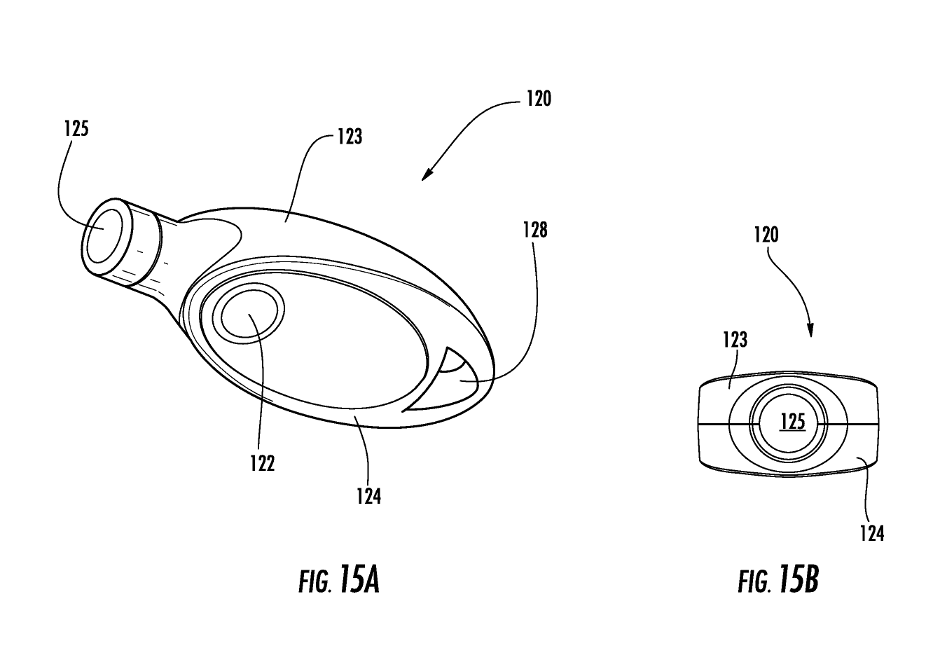

FIGS. 10-17B show another exemplary embodiment of a merchandise display security system and method including a programmable key, a merchandise security device, a programming station and a charging station according to the present invention. In this embodiment, the system and method comprise at least a programmable electronic key (also referred to herein as a merchandise security key) with inductive transfer, indicated generally at 120, and a merchandise security device with inductive transfer, indicated generally at 140, that is operated by the key 120. However, the programmable electronic key 120 is useable with any security device or locking device with inductive transfer capability that requires power transferred from the key to the device by induction, or alternatively, requires data transferred between the key and the device and power transferred from the key to the device by induction. Further examples include, but are not limited to, a door lock, a drawer lock or a shelf lock, as well as any device that prevents an unauthorized person from accessing, removing or detaching an item from a secure location or position.

The system and method may further comprise an optional programming station 60, as previously described, operable for programming the key 120 with a Security Disarm Code (SDC). For example, merchandise security key 120 and merchandise security device 140 may each be pre-programmed with the same SDC into a respective permanent memory. Alternatively, the key 120 and/or the merchandise security device 140 may be provided with only a transient memory, such that the SDC must be programmed (or reprogrammed) at predetermined time intervals. In addition to programming station 60, the system and method may further comprise an optional charging station with inductive transfer, indicated generally at 180, operable for initially charging and subsequently recharging an internal power source disposed within the key 120. The merchandise security key 120 may be provisioned with a single-use (i.e. non-rechargeable) power source, such as a conventional or extended-life battery, or alternatively, the key 120 may be provisioned with a multiple-use (i.e. rechargeable) power source, such as a conventional capacitor or rechargeable battery. In either instance, the power source may be permanent, semi-permanent (i.e. replaceable), or rechargeable, as desired. In the latter instance, charging station 180 is provided to initially charge and to subsequently recharge the power source disposed within the key 120. As previously described, programming station 60 is provided to initially program and subsequently reprogram the SDC into the programmable electronic key 120 and the key is operable to initially program the merchandise security device 140 with the SDC and to subsequently validate the SDC with the merchandise security device. The key 120 is further operable to operate the merchandise security device 140 by transferring power via induction, or by transferring both data and power to the device via induction, as will be described.

As previously described with respect programmable electronic key 20, the programmable electronic key 120 is configured to be programmed with a unique SDC by the programming station 60. The key 120 is presented to the programming station 60 and communication therebetween is initiated, for example by pressing a control button 122 provided on the exterior of the key. Data communication between the programming station 60 and the key 120 may be accomplished directly, for example by one or more electrical contacts, or indirectly, for example by wireless communication. Any form of wireless communication capable of transferring data between the programming station 60 and key 120 is possible, including without limitation, optical transmission, acoustic transmission, radio frequency (RF) transmission or inductive transmission, such as magnetic induction. In the embodiments shown and described herein, communication between programming station 60 and key 120 is accomplished by wireless optical transmission, and more particularly, by infrared (IR) transceivers provided in the programming station and the key. IR communication between the programming station 60 and the key 120, as described in greater detail in the aforementioned U.S. Pat. No. 7,737,844, provides backwards compatibility with existing electronic merchandise security devices. For purposes of describing the present invention, it is sufficient that the programming station 60 comprises a logic control circuit provided with or capable of generating a unique SDC, a memory for storing the SDC, and a suitable communication system for interfacing with the programmable electronic key 120 in the manner described herein above.

The merchandise security key 120 programmed with the SDC from the programming station 60 is positioned to operatively engage the merchandise security device 140 in the manner previously described with respect to key 20 and device 40. In the exemplary embodiment shown and described herein, the merchandise security device 140 is a cabinet lock configured to be operated by the programmable electronic key 120. Preferably, the merchandise security device 140 is a passive device, and as such, does not have an internal power source sufficient to lock and/or unlock a mechanical lock mechanism. Significant cost savings are obtained by the retailer when the merchandise security device 140 is passive since the expense of an internal power source is confined to the merchandise security key 120, and one such key is able to operate multiple security devices. If desired, the merchandise security device 140 may also be provided with a temporary power source (e.g., capacitor or limited-life battery) having sufficient power to activate an alarm, for example a piezoelectric audible alarm, that is actuated by a sensor, for example a contact, proximity or limit switch, in response to a security breach. The temporary power source may also be sufficient to communicate data, for example a SDC, from the merchandise security device 140 to the merchandise security key 120 to authenticate the security device and thereby authorize the key to provide power to the security device. Prior to the present invention, the mechanical lock mechanism was operated physically by, for example, a conventional key and tumbler or a magnetic key of the type shown and described in the aforementioned United States Patent Application Publication No. 2008/0168811. With this embodiment of the present invention, however, the mechanical lock mechanism is operated by electrical power that is transferred via induction from the key 120 to the security device 140, as will be described.

The merchandise security device 140 further comprises a logic control circuit, similar to the logic control circuit disposed within the key 120, to perform a handshake communication protocol with the logic control circuit of the key in essentially the same manner as that between the programming station 60 and the key. In essence, the logic control circuit of the key 120 and the logic control circuit of the merchandise security device 140 communicate with each other to determine whether the merchandise security device is an authorized device that does not have a security code, or is a device having a proper (i.e. matching) SDC. In the event the handshake communication protocol fails (e.g. the device is not authorized or the device has a non-matching SDC), the key 120 will not program the device 140 with the SDC, and consequently, the merchandise security device will not operate. If the merchandise security device 140 was previously programmed with a different SDC, the device will no longer communicate with the merchandise security key 120. In the event the handshake communication protocol is successful, the merchandise security key 120 permits the SDC stored in the key to be transmitted by the optical transceiver disposed within the key to a cooperating optical transceiver disposed within the merchandise security device 140 to program the device with the SDC. As will be readily apparent to those skilled in the art, the SDC may be transmitted from the merchandise security key 120 to the merchandise security device 40 alternatively by any other suitable means, including without limitation, via one or more electrical contacts, or via electromechanical, electromagnetic or magnetic conductors, as desired. Furthermore, the SDC may be transmitted by inductive transfer of data from the programmable electronic key 120 to the programmable merchandise security device 140.

On the other hand, when the handshake communication protocol is successful and the merchandise security device 140 is an authorized device having the same (i.e. matching) SDC, the logic control circuit of the key 120 causes the internal power source of the key to transfer electrical power to the device to operate the mechanical lock mechanism. More particularly, an inductive transceiver disposed within the merchandise security key 120 operatively couples to a corresponding inductive transceiver disposed within the merchandise security device 140 and transfers power from an internal battery of the key to the mechanical lock mechanism of the security device, for example to lock or unlock the security device. In the embodiments shown and described herein, the merchandise security device 140 is a cabinet lock that is affixed to one of a pair of adjacent sliding doors 102 of a conventional cabinet 100 of the type suitable for use in a retail store. Cabinet 100 is typically used by the retailer to store relatively expensive items of merchandise 110, such as mobile phones, digital cameras, Global Positioning Satellite (GPS) devices, and the like. The doors 102 overlap at the center of the cabinet 100 and the cabinet lock 140 is secured on an arm 104 of a bracket 105 affixed to the innermost door with the arm disposed between the doors. In the illustrated example, the key 120 transfers power to an electric motor, DC stepper motor, solenoid, or the like that unlocks the mechanical lock mechanism of the cabinet lock 140 so that the cabinet lock can be removed from the arm 104 of the bracket 105 and the doors moved (i.e. slid) relative to one another to access the items of merchandise 110 stored within the cabinet 100. Preferably, the arm 104 of the bracket 105 is provided with one-way ratchet teeth (FIG. 2) and the cabinet lock 140 is provided with a pair of complimentary ratchet pawls (not shown) in a conventional manner so that the key 120 is not required to lock the cabinet lock onto the arm 104 of the bracket 105. If desired, however, the cabinet lock 140 can be configured to require use of the key 120 to both unlock and lock the cabinet lock.

It will be readily apparent to those skilled in the art that the cabinet lock illustrated herein is but one of numerous types of a passive merchandise security device 140 that can be configured to be operated by a programmable electronic key 120 according to the present invention. By way of example and without limitation, the merchandise security device 140 may be a locking base for securing a merchandise display hook to a display support, such as pegboard, slatwall, bar stock or wire grid, or may be a locking end assembly for preventing the rapid removal of merchandise from the merchandise display hook. Alternatively, the merchandise security device 140 may be a merchandise security display stand comprising a mechanical lock mechanism for securing the display stand to a display support, such as a table, counter, desk, wall, or other fixed structure. Alternatively, the merchandise security device 140 may be incorporated into packaging for one or more items of merchandise comprising a mechanical lock mechanism for separating the packaging from the merchandise and/or for removing the merchandise from the packaging. Still further, the merchandise security device 140 may be a conventional door or window lock for preventing access to a room, booth, or other enclosure. In any of these or other embodiments, the merchandise security device 140 may further comprise an electronic sensor, such as a conventional proximity, limit or contact switch, and an associated electronic monitoring circuit that activates an alarm in response to the switch being actuated or the integrity of the switch or the monitoring circuit being compromised. In all embodiments, however, the merchandise security device 140 comprises a logic control circuit, or the equivalent, including a memory for storing a SDC, and a communication system for communicating the SDC with the programmable electronic key 120 to initially receive and subsequently authenticate the key for use with the device.

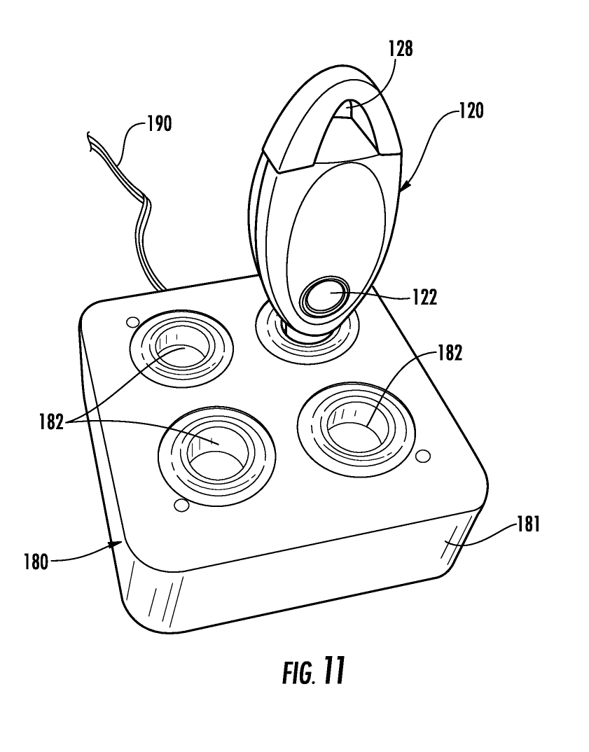

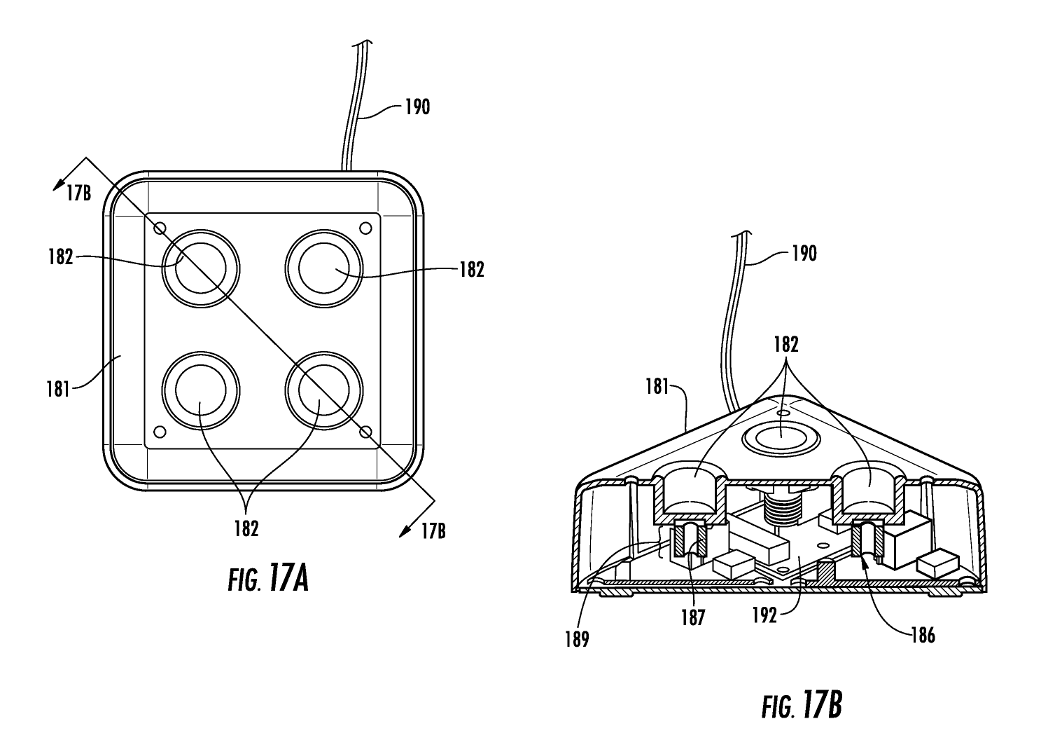

As illustrated in FIG. 11, the merchandise security system and method further comprises charging station 180 for initially charging and subsequently recharging a rechargeable battery disposed within the merchandise security key 120 via inductive transfer. The charging station 180 comprises at least one, and preferably, a plurality of charging ports 182 each sized and shaped to receive a merchandise security key 120. If desired, each charging port 182 may comprise mechanical or magnetic means for properly positioning and securely retaining the key 120 within the charging port. By way of example and without limitation, at least one, and preferably, a plurality of magnets (not shown) may be provided for positioning and retaining the key 120 within the charging port 182 of the charging station 180. However, as will be described further with reference to FIG. 17B, it is only necessary that the inductive transceiver of the merchandise security key 120 is sufficiently aligned with the corresponding inductive transceiver of the charging station 180 over a generally planar surface within the charging port 182. Thus, magnets are not required (as with charging station 80) to position, retain and maintain electrical contacts provided on the merchandise security key 120 in electrical contact with corresponding electrical contacts provided on the charging station 180. If desired, the charging station 180 may comprise an internal power source, for example, an extended-life replaceable battery or a rechargeable battery, for providing power to the key(s) 120 positioned within the charging port(s) 182. Alternatively, and as shown herein, charging station 180 may be operatively connected to an external power source by a power cord 190 having at least one conductor in a conventional manner.

An available feature of a merchandise security system and method according to the invention is that the logic control circuit of the programmable electronic key 120 may include a time-out function. More particularly, the ability of the key 120 to transfer data and power to the merchandise security device 140 is deactivated after a predetermined time period. By way of example, the logic control circuit may be deactivated after about six to about twelve hours from the time the key was programmed or last refreshed by the programming station 60. In this manner, an authorized sales associate typically must program or refresh the key 120 assigned to him at the beginning of each work shift. Furthermore, the charging station 180 may be configured to deactivate the logic control circuit of the key 120 when the key is positioned within a charging port 182. In this manner, the charging station 180 can be made available to an authorized sales associate in an unsecured location while the programming station 60 remains in a secured location without risk that a charged key 120 could be removed from the charging station and used to maliciously disarm and/or unlock a merchandise security device 140. The merchandise security key 120 would then have to be initially programmed or refreshed by the programming station 60, which as previously mentioned is monitored or maintained at a secure location, in order to reactivate the logic control circuit of the key. If desired, the charging station 180 may alternatively require a matching handshake communication protocol with the programmable electronic key 120 in the same manner as the merchandise security device 140 and the key.

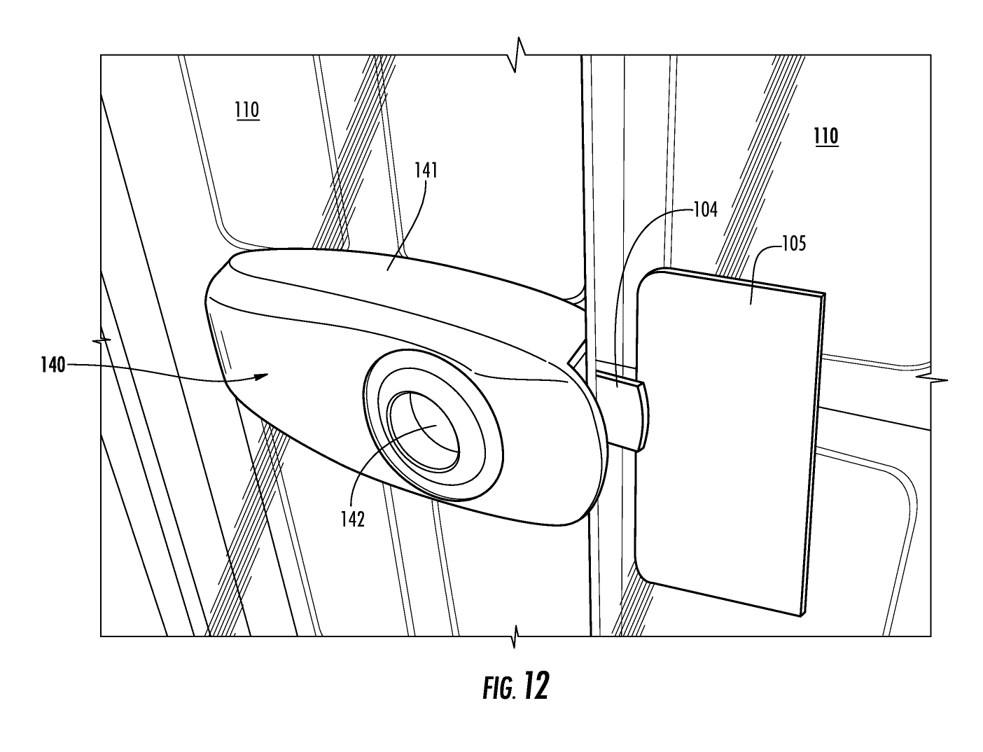

FIG. 12 shows the merchandise security device 140 with inductive transfer in greater detail. As previously mentioned, the merchandise security device 140 can be any type of security device (e.g. security display; security fixture; security packaging; conventional door/window/drawer lock; etc.) that utilizes both an electronic lock mechanism, such as an alarm or a security “handshake,” and a mechanical lock mechanism that locks and/or unlocks a conventional lock. At the same time, the merchandise security device 140 must be a passive device in the sense that it does not have an internal power source sufficient to operate the mechanical lock mechanism. As a result, the merchandise security device 140 must be configured to receive power, or alternatively, both power and data, from an external source, such as the merchandise security key 120 shown and described herein. The exemplary embodiment of the merchandise security device depicted in FIG. 12 is a cabinet lock configured to be securely affixed to the locking arm 104 of a conventional cabinet lock bracket 105. As previously described, the cabinet lock 140 comprises a logic control circuit for performing a handshake communication protocol with the logic control circuit of the merchandise security key 120 and for receiving the SDC from the key. In other embodiments, the cabinet lock 140 may be configured to transmit the SDC to the merchandise security key 120 to authenticate the security device and thereby authorize the key to transfer power to the security device. As previously mentioned, the data (e.g. handshake communication protocol and SDC) may be transmitted and received (i.e. transferred) by electrical contacts, optical transmission, acoustic transmission, radio frequency (RF) transmission or magnetic induction. In a particular embodiment, a merchandise security device 140 with inductive transfer according to the invention may both receive electrical power from the merchandise security key 120 and communicate (i.e. transmit/receive) the SDC with the key by magnetic induction.

The cabinet lock 140 comprises a housing 141 sized and shaped to contain a logic control circuit (not shown) and an internal mechanical lock mechanism (not shown). A transfer port 142 formed in the housing 141 is sized and shaped to receive a transfer probe of the merchandise security key 120, as will be described. If desired, the transfer port 142 may comprise mechanical or magnetic means for properly positioning and securely retaining the key 120 within the transfer port. By way of example and without limitation, at least one, and preferably, a plurality of magnets (not shown) may be provided for positioning and retaining the key 120 within the transfer port 142 of the cabinet lock 140. However, as previously described with respect to the merchandise security key 120 and the charging port 182 of the charging station 180, it is only necessary that the inductive transceiver of the merchandise security key 120 is sufficiently aligned with the corresponding inductive transceiver of the cabinet lock 140 over a generally planar surface within the transfer port 42. Therefore, magnets are not required to position, retain and maintain electrical contacts provided on the merchandise security key 120 in electrical contact with corresponding electrical contacts provided on the cabinet lock 140. In the particular embodiment shown and described herein, data is transferred from the merchandise security key 120 to the cabinet lock 140 by wireless communication, such as infrared (IR) optical transmission as shown and described in the aforementioned U.S. Pat. No. 7,737,843. Power is transferred from the merchandise security key 120 to the cabinet lock 140 by induction across the transfer port 142 of the cabinet lock using an inductive transceiver disposed within a transfer probe of the key that is aligned with a corresponding inductive transceiver disposed within the cabinet lock. For example, the transfer probe of the merchandise security key 120 may comprise an inductive transceiver coil that is electrically connected to the logic control circuit of the key to provide electrical power from the internal battery of the key to an inductive transceiver coil disposed within the cabinet lock 140. The inductive transceiver coil of the cabinet lock 140 then transfers the electrical power from the internal battery of the key 120 to the mechanical lock mechanism disposed within the housing 141 of the cabinet lock. As previously mentioned, the power transferred from the key 120 is used to unlock the mechanical lock mechanism, for example utilizing an electric motor, DC stepper motor, solenoid, or the like, so that the cabinet lock 140 can be removed from the arm 104 of the lock bracket 105.

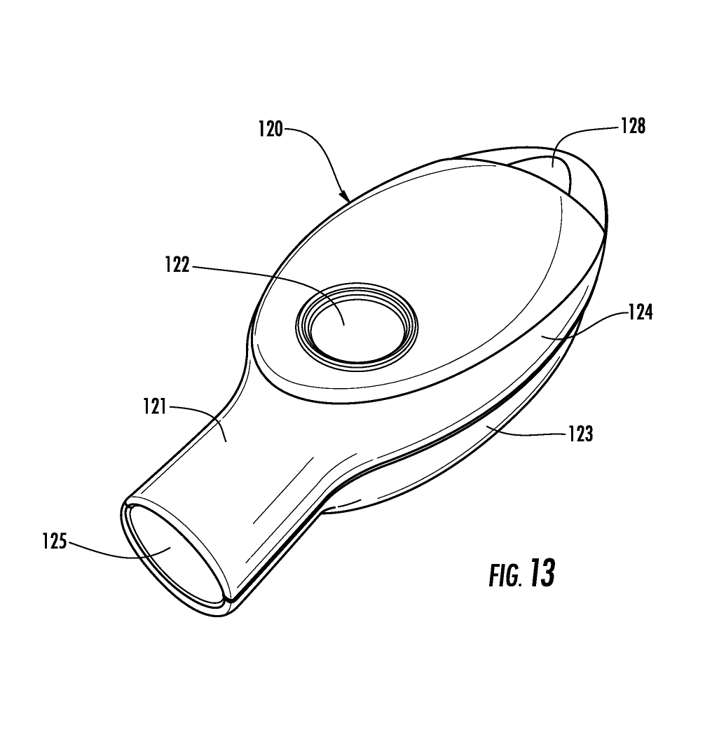

FIGS. 13-16 show the programmable electronic key 120 with inductive transfer in greater detail. As previously mentioned, the key 120 is configured to transfer both data and power to a merchandise security device 140 that comprises an electronic lock mechanism and a mechanical lock mechanism. Accordingly, the programmable electronic key 120 must be an active device in the sense that it has an internal power source sufficient to operate the mechanical lock mechanism of the merchandise security device 140. As a result, the programmable electronic key 120 may be configured to transfer both data and power from an internal source, such as a logic control circuit (i.e. data) and a battery (i.e. power) disposed within the key. The exemplary embodiment of the programmable electronic key 120 depicted herein is a merchandise security key with inductive transfer capability configured to be received within the transfer port 145 of the cabinet lock 140 shown in FIG. 12, as well as the programming port 62 of the programming station 60 (FIG. 2) and the charging port 182 of the charging station 180 (FIG. 11). The programmable electronic key 120 comprises a logic control circuit for performing a handshake communication protocol with the logic control circuit of the programming station 60 and for receiving the SDC from the programming station, as previously described. The logic control circuit of the programmable electronic key 120 further performs a handshake communication protocol with the logic control circuit of the merchandise security device 140 and transfers the SDC to the merchandise security device, as previously described. As previously mentioned, the data (e.g. handshake communication protocol and SDC) may be transferred (i.e. transmitted and received) by electrical contacts, optical transmission, acoustic transmission, radio frequency (RF) or magnetic induction. In a particular embodiment, a merchandise security key 120 with inductive transfer according to the invention may both transfer electrical power to a merchandise security device 140 and communicate (i.e. transmit/receive) the SDC with the security device by magnetic induction.

The programmable electronic key 120 comprises a housing 121 having an internal cavity or compartment that contains the internal components of the key, including without limitation the logic control circuit, memory, communication system and battery, as will be described. As shown, the housing 121 is formed by a lower portion 123 and an upper portion 124 that are joined together after assembly, for example by ultrasonic welding. The programmable electronic key 120 further defines an opening 128 at one end for coupling the key to a key chain ring, lanyard or the like. As previously mentioned, the programmable electronic key 120 further comprises a transfer probe 125 located at an end of the housing 121 opposite the opening 128 for transferring data and power to the merchandise security device 140. The transfer probe 125 is also operable to transmit and receive the handshake communication protocol and the SDC from the programming station 60, as previously described, and to receive power from the charging station 180, as will be described in greater detail with reference to FIG. 17A and FIG. 17B.

FIG. 14 shows an exemplary embodiment of an inductive coil 126 having high magnetic permeability that is adapted (i.e. sized and shaped) to be disposed within the housing 121 of the electronic key 120 adjacent the transfer probe 125. As shown herein, the inductive coil 126 comprises a highly magnetically permeable ferrite core 127 surrounded by a plurality of inductive core windings 129. The inductive core windings 129 consist of a length of a conductive wire that is wrapped around the ferrite core. As is well known, passing an alternating current through the conductive wire generates, or induces, a magnetic field around the inductive core 127. The alternating current in the inductive core windings 129 may be produced by connecting the leads 129A and 129B of the conductive wire to the internal battery of the electronic key 120 through the logic control circuit. FIG. 14 further shows an inductive coil 146 having high magnetic permeability that is adapted (i.e. sized and shaped) to be disposed within the housing 141 of the merchandise security device (i.e. cabinet lock) 140 adjacent the transfer port 142. As shown herein, the inductive coil 146 comprises a highly magnetically permeable ferrite core 147 surrounded by a plurality of inductive core windings 149 consisting of a length of a conductive wire that is wrapped around the ferrite core. Placing the transfer probe 125 of the electronic key 120 into the transfer port 142 of the cabinet lock 140 and passing an alternating current through the inductive core windings 129 of the inductive core 126 generates a magnetic field within the transfer port of the cabinet lock in the vicinity of the inductive coil 146. As a result, an alternating current is generated, or induced, in the conductive wire of the inductive core windings 149 of inductive coil 146 having leads 149A and 149B connected to the logic control circuit of the cabinet lock 140. The alternating current induced in the inductive coil 146 of the cabinet lock 140 is then transformed into a direct current in a known manner, such as via a bridge rectifier on the logic control circuit, to provide direct current (DC) power to the cabinet lock. The DC power generated in the cabinet lock 140 by the inductive coil 126 of the electronic key 120, may be used, for example, to unlock a mechanical lock mechanism disposed within the housing 141 of the cabinet lock.

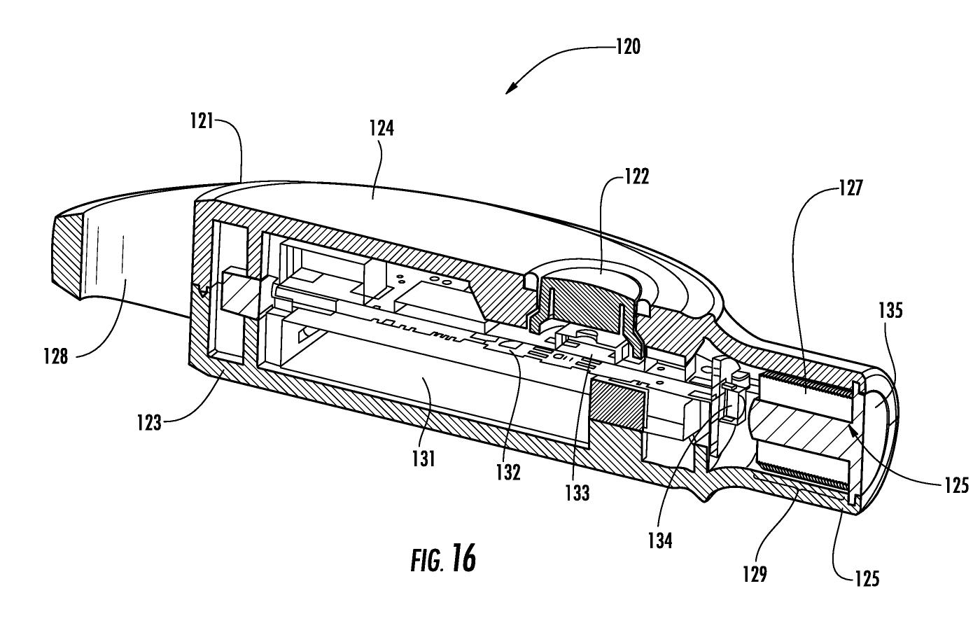

As best shown in FIG. 16, an internal battery 131 and a logic control circuit, or printed circuit board (PCB) 132 are disposed within the housing 121 of the programmable electronic key 120. Battery 131 may be a conventional extended-life replaceable battery, but preferably, is a rechargeable battery suitable for use with the charging station 180. The logic control circuit 132 is operatively coupled and electrically connected to a switch 133 that is actuated by the control button 122 provided on the exterior of the key 120 through the housing 121. Control button 122 in conjunction with switch 133 controls certain operations of the logic control circuit 132, and in particular, transmission of the data (i.e. handshake communication protocol and SDC) between the key and the programming station 60, as well as between the key and the merchandise security device 140. In that regard, the logic control circuit 132 is further operatively coupled and electrically connected to a communication system 134 for transferring (i.e. transmitting and receiving) the handshake communication protocol and SDC data. As shown and described herein, the communication system 134 is a wireless infrared (IR) transceiver for optical transmission of data between the programmable electronic key 120 and the programming station 60, and between the key and the merchandise security device 140. As a result, the transfer probe 125 of the key 120 is provided with an optically transparent or translucent filter window 135 for emitting and collecting optical transmissions between the key 120 and the programming station 60, or between the key and the merchandise security device 140, as required. Transfer probe 125 further comprises inductive coil 126 (FIG. 14) comprising inductive core 127 and inductive core windings 129 for transferring electrical power to the merchandise security device 140 and/or receiving electrical power from the charging station 180 to charge the internal battery 131, as required. Accordingly, the leads 129A and 129B (FIG. 14) of the inductive coil 126 are electrically connected to the logic control circuit 132, which in turn is electrically connected to the battery 131, in a suitable manner, for example by conductive insulated wires or plated conductors. Alternatively, the optical transceiver 134 may be eliminated and data transferred between the programmable electronic key 120 and the merchandise security device 140 via magnetic induction through the inductive coil 126.

An important aspect of a programmable electronic key 120 according to the present invention, especially when used for use in conjunction with a merchandise security device 140 as described herein, is that the key does not require a physical force to be exerted by a user on the key to operate the mechanical lock mechanism of the merchandise security device. By extension, no physical force is exerted by the key on the mechanical lock mechanism. As a result, the key cannot be unintentionally broken off in the lock, as often occurs with conventional mechanical key and lock mechanisms. Furthermore, neither the key nor and the mechanical lock mechanism suffer from excessive wear as likewise often occurs with conventional mechanical key and lock mechanisms. In addition, there is no required orientation of the transfer probe 125 of the programmable electronic key 120 relative to the charging port 182 of the charging station 180 or the transfer port 142 of the merchandise security device 140. Accordingly, any wear of the electrical contacts on the transfer probe 125, the charging port 182 or the transfer port 142 is minimized. As a further advantage, an authorized person is not required to position the transfer probe 125 of the programmable electronic key 120 in a particular orientation relative to the transfer port 142 of the merchandise security device 140 and thereafter exert a compressive and/or torsional force on the key to operate the mechanical lock mechanism of the device.

FIG. 17A and FIG. 17B show charging station 180 with inductive transfer capability in greater detail. As previously mentioned, the charging station 180 recharges the internal battery 131 of the merchandise security key 120. In certain instances, the charging station 180 also deactivates the data transfer and/or power transfer capability of the key 120 until the key has been reprogrammed with the SDC by the programming station 60. Regardless, the charging station 180 comprises a housing 181 for containing the internal components of the charging station. The exterior of the housing 181 has at least one, and preferably, a plurality of charging ports 182 formed therein that are sized and shaped to receive the transfer probe 125 of a programmable electronic key 120. As previously described, mechanical or magnetic means may be provided for properly positioning and securely retaining the transfer probe 125 within the charging port 182 such that the inductive coil 126 is in alignment with a corresponding inductive coil 186 (FIG. 17B) disposed within the housing 181 of the charging station 180 adjacent the charging port. As will be readily understood and appreciated, the inductive coil 186 adjacent the charging port 182 of the charging station 180 generates, or induces, an alternating current in the conductive wire of the inductive core windings 129 of inductive coil 126 that in turn provides DC power (for example, via a bridge rectifier on the logic control circuit 132) to charge the battery 131 of the programmable electronic key 120.

As best shown in FIG. 17B, housing 181 is sized and shaped to contain a logic control circuit, or printed circuit board (PCB) 192 that is electrically connected and operatively coupled to an inductive coil 186 adjacent each of the charging ports 182. In the manner previously described with respect to inductive coli 126 and inductive coil 146, each inductive coil 186 comprises an inductive core 187 surrounded by a plurality of inductive core windings 189 formed by a conductive wire having a pair of leads (not shown). When an alternating current is passed through the conductive wire of the inductive core windings 189 with the transfer probe 125 of the programmable electronic key 120 disposed in the charging port 182 of the charging station 180, the inductive coil 186 generates a magnetic field that induces an alternating current in the conductive wire of the inductive core windings 129 of the inductive coil 126 of the key. The alternating current in the inductive coil 126 is then transformed into DC power to charge the internal battery 131 of the programmable electronic key 120. As previously mentioned, charging station 180 may comprise an internal power source, for example, an extended-life replaceable battery or a rechargeable battery, for providing power to the key(s) 120 positioned within the charging port(s) 182. Alternatively, and as shown herein, the logic control circuit 192 of the charging station 180 is electrically connected to an external power source by a power cord 190 having at least one conductor. Furthermore, logic control circuit 192 may be operable for deactivating the data transfer and/or power transfer functions of the programmable electronic key 120, or alternatively, for activating the “timing out” feature of the key until it is reprogrammed or refreshed by the programming station 60.

That which is claimed is:

1. An electronic key for transferring power to a merchandise security device, the key comprising:
an internal power source for providing electrical power; and
a transfer probe operatively coupled and electrically connected to the internal power source for transferring electrical power from the internal power source to the merchandise security device to operate the merchandise security device such that the merchandise security device does not require an internal power source.

2. An electronic key according to claim 1, wherein the merchandise security device comprises a mechanical lock mechanism that is operated by the electrical power transferred from the internal power source.

3. An electronic key according to claim 2, wherein the transfer probe does not exert a physical force on the merchandise security device to operate the mechanical lock mechanism.

4. An electronic key according to claim 2, wherein the transfer probe is not positioned in a particular orientation relative to the merchandise security device to operate the mechanical lock mechanism.

5. An electronic key according to claim 1, further comprising a logic control circuit electrically connected to the internal power source and a communications system electrically connected to the internal power source and operatively coupled to the logic control circuit, the communication system configured to communicate data between the logic control circuit of the electronic key and a corresponding logic control circuit of the merchandise security device.

6. An electronic key according to claim 5, wherein the data comprises at least one of a security code and a handshake communication protocol.

7. An electronic key according to claim 1, wherein the electrical power is transferred from the internal power source to the merchandise security device via at least one electrical contact disposed on the transfer probe and electrically connected to the internal power source.

8. An electronic key according to claim 7, wherein the merchandise security device has a transfer port for engaging the transfer probe, and wherein the transfer port comprises at least one electrical contact corresponding to the at least one electrical contact disposed on the transfer probe.

9. An electronic key according to claim 1, wherein the electrical power is transferred from the internal power source to the merchandise security device via inductive transfer.

10. An electronic key according to claim 9, wherein the merchandise security device has a transfer port for engaging the transfer probe, and wherein the transfer probe comprises an inductive coil electrically connected to the internal power source and the transfer port comprises a corresponding inductive coil for inducing electrical power in the merchandise security device.

11. An electronic key according to claim 10, wherein the inductive coil of the transfer probe and the inductive coil of the transfer port each comprise a highly magnetically permeable ferrite core surrounded by a plurality of inductive core windings consisting of a length of a conductive wire that is wrapped around the ferrite core.

12. A security system for protecting an item of merchandise susceptible to theft, comprising:
a programmable electronic key comprising an internal power source; and
a merchandise security device that is operated by electrical power transferred from the internal power source of the programmable electronic key to the merchandise security device.

13. A security system according to claim 12, wherein the programmable electronic key is programmed with a security code and the programmable electronic key initially programs the merchandise security device with the security code.

14. A security system according to claim 13,
wherein the programmable electronic key further comprises a logic control circuit electrically connected to the internal power source, a memory for storing the security code and a communications system operatively coupled to the logic control circuit of the programmable electronic key;
wherein the merchandise security device comprises a logic control circuit, a memory for storing the security code and a communications system operatively coupled to the logic control circuit of the merchandise security device; and
wherein the communications system of the programmable electronic key and the communications system of the merchandise security device communicate to initially program the merchandise security device with the security code and to subsequently determine whether the security code of the programmable electronic key matches the security code of the merchandise security device.

15. A security system according to claim 14, wherein when the security code of the programmable electronic key matches the security code of the merchandise security device, the programmable electronic key transfers electrical power from the internal power source to the merchandise security device to operate a mechanical lock mechanism of the merchandise security device.

16. A security system according to claim 15, wherein the electrical power is transferred from the internal power source of the programmable electronic key to the mechanical lock mechanism of the merchandise security device via electrical contact between at least one electrical contact disposed on a transfer probe of the programmable electronic key and at least one electrical contact disposed on a transfer port of the merchandise security device when the transfer probe engages the transfer port.

17. A security system according to claim 15, wherein the electrical power is transferred from the internal power source of the programmable electronic key to the mechanical lock mechanism of the merchandise security device via inductive transfer between an inductive coil disposed within a transfer probe of the programmable electronic key and an inductive coil disposed within a transfer port of the merchandise security device when the transfer probe engages the transfer port.

18. A security system according to claim 12, further comprising a charging station for periodically charging the internal power source of the programmable electronic key.

19. A security system according to claim 13, further comprising a programming station for programming the programmable electronic key with the security code.

20. A method for protecting an item of merchandise susceptible to theft, comprising:
providing an active electronic key having an internal power source;
providing a passive merchandise security device having a mechanical lock mechanism;
transferring electrical power from the internal power source of the electronic key to the merchandise security device to operate the mechanical lock mechanism.

21. A method according to claim 20, wherein transferring electrical power from the internal power source of the electronic key comprises establishing electrical contact between at least one electrical contact disposed on the electronic key and at least one corresponding electrical contact disposed on the merchandise security device.

22. A method according to claim 20, wherein transferring electrical power from the internal power source of the electronic key comprises passing an electrical current through an inductive coil of the electronic key to generate a magnetic field in the vicinity of a corresponding inductive coil of the merchandise security device and thereby induce an electrical current in the inductive coil of the merchandise security device.

23. A method according to claim 20, wherein the electronic key has a security code and further comprising initially programming the merchandise security device with the security code and subsequently determining whether the security code of the electronic key matches the security code of the merchandise security device.
